(19) United States
(12) Patent Application Publication
(10) Pub. No.: US 2025/0106435 A1
(43) Pub. Date: Mar. 27, 2025

(54) METHOD AND DEVICE FOR DERIVING INTRA MULTIPLE REFERENCE LINE (MRL) PREDICTION SYNTAX BY DERIVING BOUNDARY AREA OF ATLAS IMAGE

(71) Applicants: Electronics and Telecommunications Research Institute, Daejeon (KR); Dong-A University Research Foundation For Industry-Academy Cooperation, Busan (KR)

(72) Inventors: Won Sik CHEONG, Daejeon (KR); Kug Jin YUN, Daejeon (KR); Dong San JUN, Daejeon (KR); Seon Jae KIM, Daejeon (KR)

(73) Assignees: Electronics and Telecommunications Research Institute, Daejeon (KR); Dong-A University Research Foundation For Industry-Academy Cooperation, Busan (KR)

(21) Appl. No.: 18/895,011

(22) Filed: Sep. 24, 2024

(30) Foreign Application Priority Data
Sep. 27, 2023 (KR) 10-2023-0131151
Sep. 19, 2024 (KR) 10-2024-0126930

(51) Int. Cl. H04N 19/70; H04N 19/117; H04N 19/176

(52) U.S. Cl. CPC H04N 19/70; H04N 19/117; H04N 19/176

(57) ABSTRACT

An image encoding/decoding method, device and recording medium of the present disclosure may include deriving an atlas boundary from a reference sample region of a current block, determining, in response to the existence of the atlas boundary, whether an index of a reference sample line having the atlas boundary is greater than a threshold value, and adaptively transmitting a multiple reference line (MRL) syntax of the current block encoded by a changed binarization method based on the atlas boundary according to whether an index of a reference sample line having the atlas boundary is greater than a threshold value.

### TECHNICAL FIELD

The present disclosure may be utilized in atlas image encoding/decoding method, device and recording medium fields.

### BACKGROUND ART

The MPEG Immersive Video (MIV) encoding standard is a compression standard for encoding/decoding and rendering used to reproduce an image that is displayed when moving in 3DoF (Degree of Freedom), 3DoF+ and 6DoF.

3DoF+ may support motion parallax for a very limited movement like a slight head motion in a sitting environment through a plurality of images including an omnidirectional scene and multiple virtual viewpoint images synthesized based thereon.

6DoF may support the degree of freedom for a motion in six directions (left-right movement, up-down movement, forward-backward movement, pitch, roll, yaw).

A goal of the MIV encoding standard technology is an interface for viewing an immersive video and the reproduction of a high-quality viewport image along with the compression efficiency of traditional video coding.

### DISCLOSURE

### Technical Problem

Due to the characteristics of an atlas image, multiple image patches exist within one screen, and when intra prediction is performed, prediction accuracy may be reduced when a different patch region is used as a reference sample.

For the same reason as above, when MRL prediction is performed for a region that gets out of a boundary of a current image patch among the reference sample regions during the process of performing the encoding of an atlas image, a high rate distortion (RD) cost may occur, so accordingly, an overhead bit may occur due to a “intra_luma_ref_idx” syntax showing a position of a reference sample.

The present disclosure proposes a method for implicitly deriving a MRL syntax by deriving an atlas boundary region among the reference samples and filtering a reference sample line used for MRL prediction when performing intra prediction for a current block to improve the compression efficiency of am atlas image.

### Technical Solution

An image encoding/decoding method, device and recording medium of the present disclosure may include deriving an atlas boundary from a reference sample region of a current block, in response to the existence of the atlas boundary, determining whether an index of a reference sample line having the atlas boundary is greater than a threshold value, and adaptively transmitting a multiple reference line (MRL) syntax of the current block encoded by a changed binarization method based on the atlas boundary according to whether an index of a reference sample line having the atlas boundary is greater than a threshold value.

In an image encoding/decoding method, device and recording medium of the present disclosure, deriving the atlas boundary may be performed by applying a filter for calculating at least one of a horizontal gradient or a vertical gradient for a top reference pixel column.

In an image encoding/decoding method, device and recording medium of the present disclosure, deriving the atlas boundary may be performed by applying a filter for calculating at least one of a horizontal gradient or a vertical gradient for a left reference pixel column.

In an image encoding/decoding method, device and recording medium of the present disclosure, deriving the atlas boundary may be performed by applying a filter for calculating at least one of a horizontal gradient or a vertical gradient for a reference sample region that gets out of a boundary of a height and a width of the current block.

In an image encoding/decoding method, device and recording medium of the present disclosure, the threshold value may be determined by a pre-defined reference table.

In an image encoding/decoding method, device and recording medium of the present disclosure, in response to an index of a reference sample line having the atlas boundary being less than or equal to the threshold value, the MRL syntax may not be transmitted.

In an image encoding/decoding method, device and recording medium of the present disclosure, in response to an index of a reference sample line having the atlas boundary being greater than the threshold value, the MRL syntax encoded by a changed binarization method based on the atlas boundary may be transmitted.

In an image encoding/decoding method, device and recording medium of the present disclosure, the MRL syntax encoded by the changed binarization method may have a value obtained by subtracting a specific value from the maximum available MRL index value configured in any one of a Video Parameter Set (VPS), a Sequence Parameter Set (SPS) or a Picture Parameter Set (PPS).

In an image encoding/decoding method, device and recording medium of the present disclosure, the maximum available MRL index value may be 5, and the specific value may be 3.

### Technical Effect

A prediction technology of the present disclosure may have improved encoding/decoding efficiency without reducing encoding/decoding efficiency unlike the existing technology even when multiple image patches exist in one screen of an atlas image.

### BRIEF DESCRIPTION OF DRAWINGS

FIG. 1 shows the overall structure of a test model for MIV (TMIV).

FIG. 2 shows a difference between a natural image and an atlas image generated from a TMIV.

FIG. 3 shows an example of a neighboring reference sample line of a current block.

FIG. 4 shows the overall flow of a method for deriving an intra MRL prediction syntax by deriving an atlas boundary region proposed by a video encoder.

FIG. 5 shows an embodiment of a method for transmitting a MRL syntax of the present disclosure.

FIG. 6 shows various embodiments using a gradient filter.

FIG. 7 represents an embodiment in which “intra_luma_ref_idx” is binarized by using a truncated rice technique for each of the existing method and a proposed method when N is 5 and M is 3.

FIG. 8 represents an embodiment in which “intra_luma_ref_idx” is binarized by using a truncated rice technique for each of the existing method and a proposed method when N is 5 and M is 5.

FIG. 9 shows an embodiment of a method for receiving a MRL syntax from a decoding perspective.

### MODE FOR INVENTION

As the present disclosure may make various changes and have several embodiments, specific embodiments will be illustrated in a drawing and described in detail. But, it is not intended to limit the present disclosure to a specific embodiment, and it should be understood that it includes all changes, equivalents or substitutes included in an idea and a technical scope for the present disclosure. A similar reference numeral was used for a similar component while describing each drawing.

A term such as first, second, etc. may be used to describe various components, but the components should not be limited by the terms. The terms are used only to distinguish one component from other components. For example, without going beyond a scope of a right of the present disclosure, a first component may be referred to as a second component and similarly, a second component may be also referred to as a first component. A term of and/or includes a combination of a plurality of relative entered items or any item of a plurality of relative entered items.

When a component is referred to as being “linked” or “connected” to other component, it should be understood that it may be directly linked or connected to that other component, but other component may exist in the middle. On the other hand, when a component is referred to as being “directly linked” or “directly connected” to other component, it should be understood that other component does not exist in the middle.

As terms used in this application are just used to describe a specific embodiment, they are not intended to limit the present disclosure. Expression of the singular includes expression of the plural unless it clearly has a different meaning contextually. In this application, it should be understood that a term such as “include” or “have”, etc. is to designate the existence of characteristics, numbers, steps, motions, components, parts or their combinations entered in the specification, but is not to exclude a possibility of addition or existence of one or more other characteristics, numbers, steps, motions, components, parts or their combinations in advance.

Hereinafter, referring to the attached drawings, the embodiments of the present disclosure will be described in detail. Hereinafter, the same reference numeral is used for the same component in a drawing and an overlapping description for the same component is omitted.

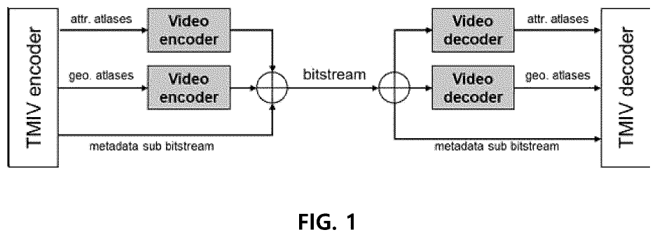

FIG. 1 shows the overall structure of a test model for MIV (TMIV).

Currently, a TMIV may perform preprocessing on a multi-view video to generate a small number of atlas images and perform compression by using a traditional video codec such as High Efficiency Video Coding (HEVC), Versatile Video Coding (VVC), etc.

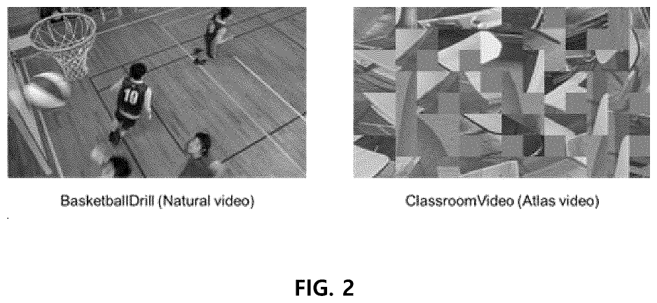

FIG. 2 shows a difference between a natural image and an atlas image generated from a TMIV.

During the standardization process of traditional video codecs, a test sequence used as a Common Test Conditions (CTC) is mostly images obtained from nature, and there is a problem that the characteristics of an atlas image generated from a TMIV are not considered.

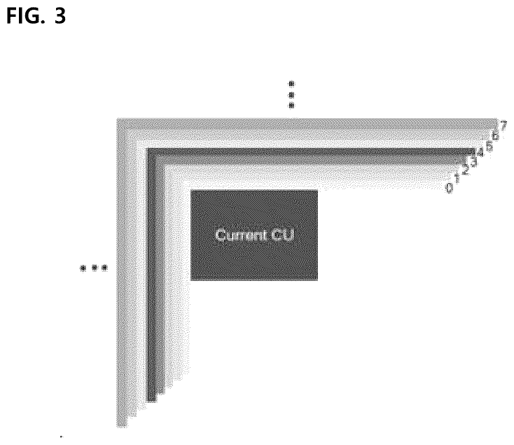

FIG. 3 shows an example of a neighboring reference sample line of a current block.

A Multiple Reference Line (MRL) may be a technology for using a neighboring reference sample (of a neighboring reference sample line) of a current block to improve the accuracy of intra prediction. Here, a neighboring reference sample may include only a reference sample closest to a current block (the 0-th line of FIG. 3) or may include a reference sample that is 1 pixel or 3 pixels away from a current block other than the closest reference sample. However, a MRL of the present disclosure is not limited thereto, and the neighboring reference sample may include a reference sample that is 1, 3, 5, 7 or 12 pixels away from a current block.

As an embodiment, when a MRL is applied, a “intra_luma_ref_idx” syntax representing a position of a reference sample during a signaling process for an intra prediction block may be added. A corresponding syntax may be transmitted to a decoder by performing Truncated Rice binarization and entropy encoding.

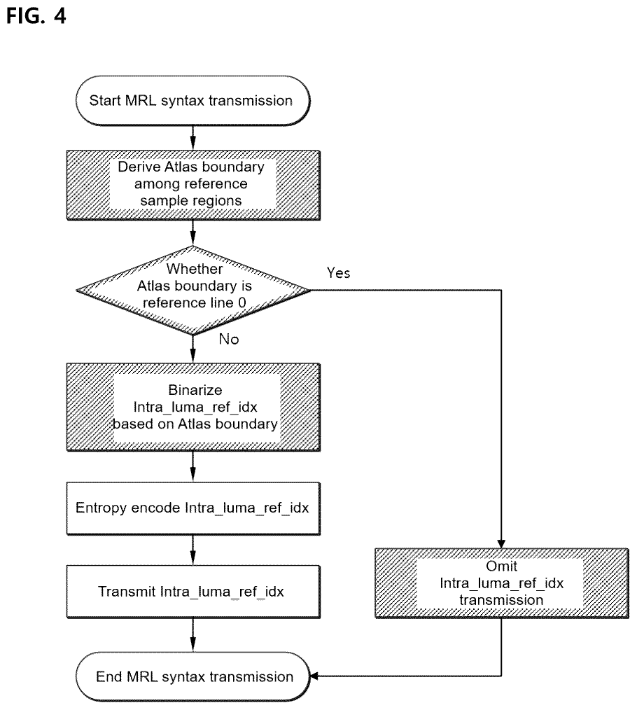

FIG. 4 shows the overall flow of a method for deriving an intra MRL prediction syntax by deriving an atlas boundary region proposed by a video encoder.

A hatched block in FIG. 4 may correspond to a process of deriving a MRL syntax changed by a proposed method.

Specifically, a video encoder may derive an atlas boundary of a reference sample region before performing MRL syntax (intra_luma_ref_idx) transmission, and may change a binarization method of a MRL syntax or omit transmission based on a derived boundary.

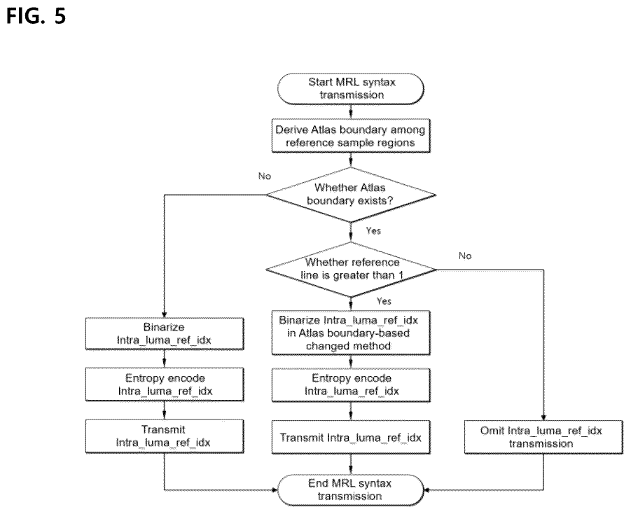

FIG. 5 shows an embodiment of a method for transmitting a MRL syntax of the present disclosure.

### (1) (A Step of) Deriving an Atlas Boundary Among the Reference Sample Regions

An atlas boundary may be derived by changing a pixel value in a horizontal or vertical direction.

To utilize the feature, an atlas boundary may be determined by using a filter that may calculate a gradient of a pixel value (=a gradient filter).

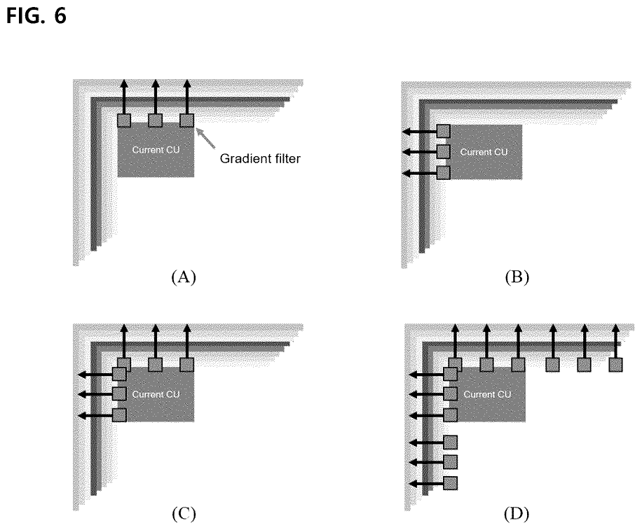

FIG. 6 shows various embodiments using a gradient filter.
(A) As an example, an atlas boundary may be determined by applying a filter to calculate a horizontal gradient for at least one pixel column (or line) among the top reference samples.
(B) As an example, an atlas boundary may be determined by applying a filter to calculate a vertical gradient for at least one pixel column among the left reference samples.
(C) As an example, an atlas boundary may be determined through a weighted sum, an average, dispersion, etc. by calculating each gradient or using a filter that calculates a horizontal gradient and a vertical gradient together in order to derive an atlas boundary by using top and left reference samples.
(D) As an example, an atlas boundary may be determined through a method corresponding to Sections a, b and c above for a reference sample region that gets out of a boundary of a height and a width of a current block.
(E) As an example, an atlas boundary may be determined in a reference sample region by all combinations of at least one of the sections.

A threshold value that may be obtained from a decoder side such as a difference from a gradient calculated in a neighboring pixel to determine an atlas boundary, a predefined reference table, etc. may be designated to compare a value derived through a gradient filter, determining an atlas boundary.

Whether an atlas boundary exists within a reference sample region may be confirmed as a result of deriving an atlas boundary, and when a boundary exists, a position where an atlas boundary exists may be confirmed and stored through at least one reference sample line index (bdryldx).

### 2-1) When an Atlas Boundary Does Not Exist

In Section 1) above, when it is determined that an atlas boundary does not exist within a reference sample region, “intra_luma_ref_idx” may be transmitted according to the existing MRL syntax transmission method.

### 2-2) When an Atlas Boundary Exists and a Reference Line is Less Than or Equal to 1

(=when an atlas boundary exists and a reference line index value in which an atlas boundary is included is less than or equal to 1)

In Section 1) above, when at least one atlas boundary exists within a reference sample region and reference line 0 or 1 is an atlas boundary, “intra_luma_ref_idx” transmission may be omitted, and when a decoder performs intra prediction, a prediction block may be generated by using a predefined reference line index (greater than or equal to 0).

### 2-3) When an Atlas Boundary Exists and is Greater Than Reference Line 1

(=when an atlas boundary exists and a reference line index value in which an atlas boundary is included is greater than 1)

In Section 1 above, when at least one atlas boundary exists within a reference sample region and the smallest value (bdryldx_{Min}, M) among the reference line indexes representing an atlas boundary is greater than 1, a binarization method of a “intra_luma_ref_idx” syntax may be changed and transmitted.

### 3) A Change in an intra_luma_ref_idx Binarization Method: Executed in Case of 2-3)

(it means that intra_luma_ref_idx is encoded by using a changed binarization method)

A binarization method of “intra_luma_ref_idx” may be changed according to the smallest value (bdryldxmin) among the reference line indexes where an atlas boundary exists confirmed in Section 2-3) above.

If the maximum available MRL index configured in a Profile, a Tier, a Video Parameter Set (VPS), a Sequence Parameter Set (SPS), a Picture Parameter Set (PPS), a Slice Header (SH), etc. of a video encoder is N, a MRL index that may be received for each prediction block may be adjusted to a value smaller than N (M) or a value obtained by subtracting 1 according to a proposed method.

A video encoder/decoder performs “intra_luma_ref_idx” binarization based on the M for each prediction block, and in this case, a binarization technique may use Truncated Rice, Exponential Golomb, Fixed Length, or other binarization methods that the maximum value is determined.

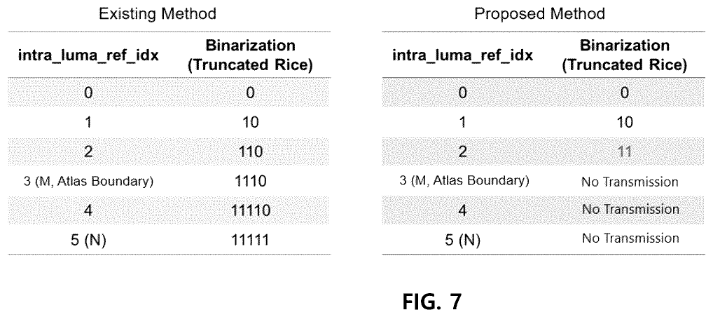

FIG. 7 represents an embodiment in which “intra_luma_ref_idx” is binarized by using a truncated rice technique for each of the existing method and a proposed method when N is 5 and M is 3.

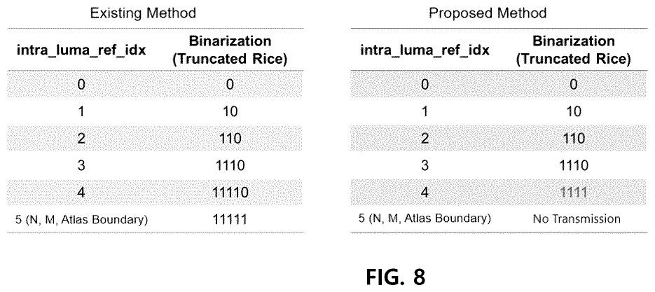

FIG. 8 represents an embodiment in which “intra_luma_ref_idx” is binarized by using a truncated rice technique for each of the existing method and a proposed method when N is 5 and M is 5.

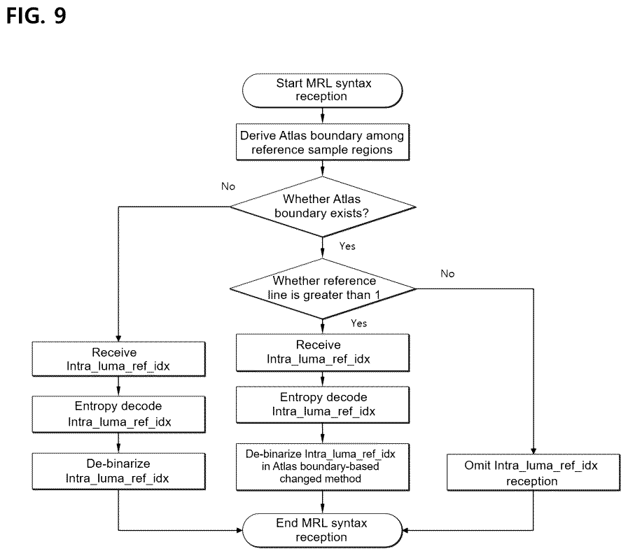

FIG. 9 shows an embodiment of a method for receiving a MRL syntax from a decoding perspective.

A description above is mainly given from an encoding perspective, but it may also be applied from a decoding perspective.

Specifically, a decoder may also perform a step of deriving an atlas boundary among the reference sample regions, determine whether a reference line is greater than 1 according to whether an atlas boundary exists, and receive intra_luma_ref_idx according to whether a reference line is greater than 1 and decode it by using a changed debinarization method.

In other words, only the order of performing a step of transmitting intra_luma_ref_idx after performing a step of performing encoding according to a binarization method is changed to the order of performing a step of performing decoding according to a debinarization method after performing a step of receiving intra_luma_ref_idx, and all descriptions above from an encoding perspective may be applied.

As an example, when an atlas boundary does not exist, “intra_luma_ref_idx” may be received according to the existing MRL syntax transmission method when it is determined that an atlas boundary does not exist within a reference sample region at a step of deriving an atlas boundary among the reference sample regions.

As an example, when an atlas boundary exists and reference line 0 or 1 is an atlas boundary, the reception of “intra_luma_ref_idx” may be omitted. In this case, a decoder may generate a prediction block by using a predefined reference line index (greater than or equal to 0) when performing intra prediction.

As an example, when an atlas boundary exists and the smallest value (bdryldx_{Min}, M) among the reference line indexes representing an atlas boundary is greater than 1, a “intra_luma_ref_idx” syntax may be received and decoded by a changed binarization method.

Hereinafter, specific details are duplicated, so they are omitted.

Exemplary methods of the present disclosure are expressed as a series of operations for clarity of a description, but it is not intended to limit order in which steps are performed and if necessary, each step may be performed simultaneously or in different order. In order to implement a method according to the present disclosure, other step may be additionally included in an exemplary step or some steps may be excluded and the remaining steps may be included or some steps may be excluded and an additional other step may be included.

A variety of embodiments of the present disclosure do not enumerate all possible combinations, but are intended to describe a representative aspect of the present disclosure, and matters described in a variety of embodiments may be applied independently or in combination of two or more.

In addition, a variety of embodiments of the present disclosure may be implemented by hardware, firmware, software or a combination thereof. For implementation by hardware, implementation may be performed by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, etc.

A scope of the present disclosure includes software or machine-executable instructions which execute an operation according to a method of a variety of embodiments on a device or a computer (e.g., an operating system, an application, a firmware, a program, etc.), and a non-transitory computer-readable medium that such software or instruction, etc. is stored and executable on a device or a computer.

1. An image encoding method, the method comprising:
deriving an atlas boundary from a reference sample region of a current block;
determining, in response to an existence of the atlas boundary, whether an index of a reference sample line having the atlas boundary is greater than a threshold value;
adaptively transmitting, according to whether the index of the reference sample line having the atlas boundary is greater than the threshold value, a multiple reference line (MRL) syntax of the current block encoded by a changed binarization method based on the atlas boundary.

2. The method of claim 1, wherein:
deriving the atlas boundary is performed by applying a filter for calculating at least one of a horizontal gradient or a vertical gradient for a top reference pixel column.

3. The method of claim 1, wherein:
deriving the atlas boundary is performed by applying a filter for calculating at least one of a horizontal gradient or a vertical gradient for a left reference pixel column.

4. The method of claim 1, wherein:
deriving the atlas boundary is performed by applying a filter for calculating at least one of a horizontal gradient or a vertical gradient for a reference sample region that gets out of a boundary of a height and a width of the current block.

5. The method of claim 1, wherein:
the threshold value is determined by a pre-defined reference table.

6. The method of claim 1, wherein:
in response to the index of the reference sample line having the atlas boundary being less than or equal to the threshold value, the MRL syntax is not transmitted.

7. The method of claim 1, wherein:
in response to the index of the reference sample line having the atlas boundary being greater than the threshold value, the MRL syntax encoded by the changed binarization method based on the atlas boundary is transmitted.

8. The method of claim 7, wherein:
the MRL syntax encoded by the changed binarization method has a value obtained by subtracting a specific value from a maximum available MRL index value configured in any one of a Video Parameter Set (VPS), a Sequence Parameter Set (SPS) or a Picture Parameter Set (PPS).

9. The method of claim 8, wherein:
the maximum available MRL index value is 5,
the specific value is 3.

10. An image decoding method, the method comprising:
deriving an atlas boundary from a reference sample region of a current block;
determining, in response to an existence of the atlas boundary, whether an index of a reference sample line having the atlas boundary is greater than a threshold value;
decoding, according to whether the index of the reference sample line having the atlas boundary is greater than the threshold value, the MRL syntax by a changed binarization method based on the atlas boundary through adaptively receiving a multiple reference line (MRL) syntax of the current block.

11. The method of claim 10, wherein:
deriving the atlas boundary is performed by applying a filter for calculating at least one of a horizontal gradient or a vertical gradient for a reference sample region that gets out of a boundary of a height and a width of the current block.

12. The method of claim 10, wherein:
in response to the index of the reference sample line having the atlas boundary being less than or equal to the threshold value, the MRL syntax is not received.

13. The method of claim 10, wherein:
in response to the index of the reference sample line having the atlas boundary being greater than the threshold value, the MRL syntax encoded by the changed binarization method based on the atlas boundary is received.

14. The method of claim 13, wherein:
the MRL syntax encoded by the changed binarization method has a value obtained by subtracting a specific value from a maximum available MRL index value configured in any one of a Video Parameter Set (VPS), a Sequence Parameter Set (SPS) or a Picture Parameter Set (PPS).

15. A computer readable recording medium storing a bitstream generated by an image encoding method, wherein the image encoding method comprising:
deriving an atlas boundary from a reference sample region of a current block;
determining, in response to an existence of the atlas boundary, whether an index of a reference sample line having the atlas boundary is greater than a threshold value;
adaptively transmitting, according to whether the index of the reference sample line having the atlas boundary is greater than the threshold value, a multiple reference line (MRL) syntax of the current block encoded by a changed binarization method based on the atlas boundary.
